(19) United States
(12) Patent Application Publication
(10) Pub. No.: US 2011/0109536 A1
(43) Pub. Date: May 12, 2011

(54) LIQUID CRYSTAL DISPLAY AND METHOD FOR TESTING SAME

(75) Inventors: SHUN-MING HUANG, Shenzhen (CN); XI-JIAN GUO, Shenzhen (CN)

(73) Assignees: INNOCOM TECHNOLOGY (SHENZHEN) CO., LTD., Shenzhen City (CN); CHIMEI INNOLUX CORPORATION, Miao-Li County (TW)

(21) Appl. No.: 12/902,166

(22) Filed: Oct. 12, 2010

(30) Foreign Application Priority Data
Nov. 12, 2009 (CN) 200910309612.8

(51) Int. Cl. G09G 3/36

(52) U.S. Cl. 345/99

(57) ABSTRACT

A liquid crystal display (LCD) includes an interface circuit configured to provide a test enable signal when the liquid crystal display is in a test mode; a timing control circuit configured to provide build in system test (BIST) data signals corresponding to at least one predetermined BIST image and a high voltage stress (HVS) start signal according to the test enable signal; a DC/DC converter configured to generate test-related voltages in response to the HVS starting signal; a data driver configured to provide a plurality of test gray voltage signals according to the BIST data signals and the test-related voltages; a scanning driver configured to provide a plurality of test scanning signals according to the test-related voltages; and a liquid crystal panel configured to receive the test gray voltage signals and test scanning signals. A method for testing an LCD is also provided.

### BACKGROUND

1. Technical Field

The present disclosure relates to liquid crystal display (LCD) technology, and more particularly, to an LCD and a method for testing the LCD.

2. Description of Related Art

LCDs have the advantages of portability, low power consumption, and low radiation, and thus are widely used in various portable information technology products, such as notebooks, personal digital assistants, video cameras, and the like.

To improve quality, LCDs are tested before being released to market. Commonly used testing methods include a build in system testing (BIST) method and a high voltage stress (HVS) testing method. In the BIST method, an LCD is driven to display predetermined images to determine whether defects are present. Upon determination that defects are present, the HVS testing method is additionally implemented, and the LCD is provided with some testing voltages exceeding driving voltages, to further determine the presence of defects.

However, two testing methods utilize discrete mechanisms, requiring separate control signals, and as such, the two methods must be implemented separately. Testing efficiency of the process is thus low, and utilization of the HVS testing method requires additional test apparatus, complicating the testing process.

What is needed is an LCD that can overcome the described limitations.

### SUMMARY

An aspect of the disclosure relates to an LCD including an interface circuit configured to provide a test enable signal when the liquid crystal display is in a test mode; a timing control circuit configured to provide build in system test (BIST) data signals corresponding to at least one predetermined BIST image and a high voltage stress (HVS) start signal according to the test enable signal; a DC/DC converter configured to generate test-related voltages in response to the HVS starting signal; a data driver configured to provide a plurality of test gray voltage signals according to the BIST data signals and the test-related voltages; a scanning driver configured to provide a plurality of test scanning signals according to the test-related voltages; and a liquid crystal panel configured to receive the test gray voltage signals and test scanning signals.

An aspect of the disclosure relates to a method for testing an LCD including the following steps: providing a test enable signal to a timing control circuit of the liquid crystal display; in response to the test enable signal, the timing controller providing build in system test (BIST) data signals to a data driver of the liquid crystal display, and a HVS starting signal to a DC/DC converter of the liquid crystal display; in response to the HVS starting signal, the DC/DC converter providing test-related voltages to the data driver and the scanning driver of the liquid crystal display; generating, by the data driver, a plurality of test gray voltage signals according to the test-related voltages and the BIST data signals, and generating, by the scanning driver, a plurality of test scanning signals according to the test-related voltages; and outputting the test gray voltage signals and the test scanning signals to a liquid crystal panel, whereby a BIST testing and an HVS testing are performed on the liquid crystal display simultaneously.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views.

FIG. 1 is a block diagram of an LCD according to an embodiment of the present disclosure, the LCD including a DC/DC converter.

FIG. 2 is a circuit diagram of one embodiment of the DC/DC converter of the LCD of FIG. 1.

FIG. 3 is a flowchart of a testing method of an LCD according to another embodiment of the present disclosure.

### DETAILED DESCRIPTION

Reference will now be made to the drawings to describe certain exemplary embodiments of the present disclosure in detail.

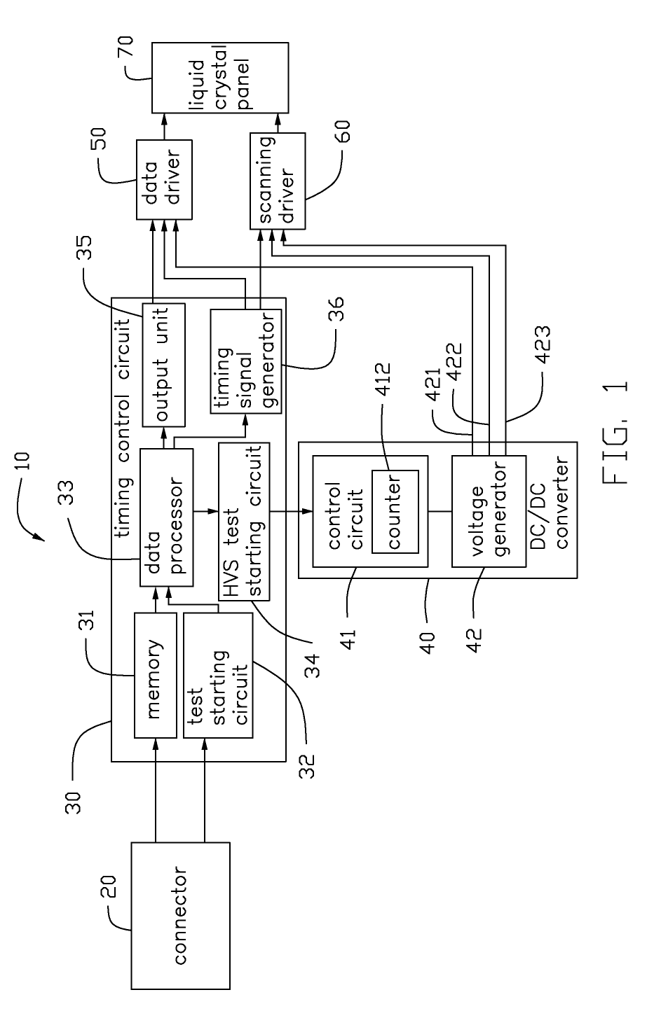

FIG. 1 is a block diagram of an LCD according to an embodiment of the present disclosure. The LCD 10 includes a connector 20, a timing control circuit 30, a DC/DC converter 40, a scanning driver 60, a data driver 50, and a liquid crystal panel 70.

The connector 20 is configured to transmit a test enable signal to the timing control circuit 30 when the LCD 10 is in a test mode, and transmit normal image data to the timing control circuit 30 when the LCD 10 is in a normal working mode. In one embodiment, the connector 20 can be an interface circuit such as a low voltage differential signaling (LVDS) connector, which may include a BIST pin (not shown) for outputting the test enable signal.

The timing control circuit 30 includes a test initiation circuit 32, a memory 31, a data processor 33, an HVS test initiation circuit 34, a timing signal generator 36, and an output unit 35. The test initiation circuit 32 is configured to output a BIST starting signal to the data processor 33 in response to the test enable signal during the test mode. The memory 31 may be a data latch configured to receive and latch the normal image data and provide the normal image data to the data processor 33 during the normal working mode. The data processor 33 is configured to selectively provide data signals corresponding to predetermined BIST image data or the normal image data to the output unit 351, providing control signals to the timing signal generator 36 directing the timing signal generator 36 to generate timing signals and provide a HVS enable signal to the HVS test initiation circuit 34 in response to the BIST starting signal. The HVS test initiation circuit 34 is configured to provide a HVS starting signal to the DC/DC converter 40 according to the HVS enable signal. The output unit 35 is configured to output the BIST image data or the normal image data to the data driver 50. The timing signal generator 36 is configured to provide timing signals to control timings of the data driver 50 and the scanning driver 60 according to the control signals output by the data processor 33, and in particular, the timing signal generator 36 may generate a first timing signal when the control signal corresponds to the normal image data, and a second timing signal when the control signal corresponds to the predetermined BIST image data.

The DC/DC converter 40 is configured to provide a test reference voltage V_{AVDD1} to the data driver 50, and provide a test high-level voltage V_{GH1} and a test low-level voltage V_{GL1} to the scanning driver 60 when the LCD 10 is in the testing mode. Moreover, the DC/DC converter 40 is also configured to provide a reference voltage V_{AVDD} to the data driver 50, and provide a high-level voltage V_{GH} and a low-level voltage V_{GL} to the scanning driver 60 when the LCD 10 is in the normal working mode. The DC/DC converter 40 includes a control circuit 41 and a voltage generator 42. The control circuit 41 is configured to direct the voltage generator 42 to generate and output the test-related voltages (i.e., the test reference voltage V_{AVDD1}, the test high-level voltage V_{GH1}, and the test low-level voltage V_{GL1}) upon receiving the HVS starting signal, for example, when the LCD 10 is in the test mode. The control circuit 41 is also configured to direct the voltage generator 42 to generate and output the normal working voltages (i.e., the reference voltage V_{AVDD}, the high-level voltage V_{GH}, and the low-level voltage V_{GL}) without the reception of the HVS starting signal, for example, when the LCD 10 is in the normal working mode.

Moreover, the control circuit 41 may further include a timer 412, and the control circuit 41 can utilize the timer 412 to control a time period of the HVS testing process. For example, the timer 412 may be triggered to count in response to the HVS starting signal, whereby the voltage generator 42 can be directed to output the test-related voltages, and when the timer 412 reaches a predetermined maximum value, the control circuit 41 may inform the voltage generator 42 of an ending of the HVS testing process, such that the voltage generator 42 is directed to stop outputting the test-related voltages, and instead, to output the normal working voltages.

The scanning driver 60 is configured to provide a plurality of test scanning signals to the liquid crystal panel 70 according to the test high-level voltage VGH1, the test low-level voltage VGL1, and the corresponding timing signals when the LCD 10 is in the test mode, and provide a plurality of normal scanning signals to the liquid crystal panel 70 according to the high-level voltage VGH, the low-level voltage VGL, and the corresponding timing signals when the LCD 10 is in the normal working mode. The data driver 50 is configured to provide a plurality of test gray voltage signals to the liquid crystal panel 70 according to the predetermined BIST image data and the test reference voltage V_{AVDD1}, and provide a plurality of normal gray voltage signals to the liquid crystal panel 70 according to the normal image data and the reference voltage V_{AVDD}.

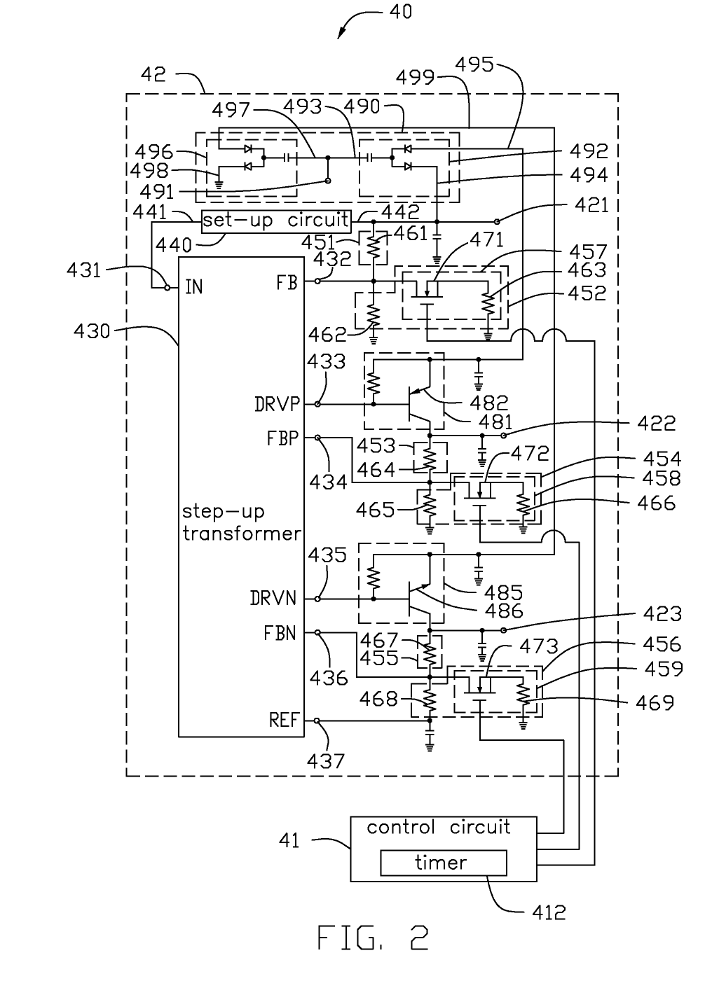

Referring to FIG. 2, a circuit diagram of the DC/DC converter 40 is shown. The voltage generator 42 includes a V_{AVDD} output terminal 421, a V_{GH} output terminal 422, a V_{GL} output terminal 423, a step-up transformer 430, a set-up circuit 440, a gate reference voltage generator 490, a first voltage control circuit 481, a second voltage control circuit 482, a first divider circuit 451, a second divider circuit 452, a third divider circuit 453, a fourth divider circuit 454, a fifth divider circuit 455, and a sixth divider circuit 456.

The step-up transformer 430 includes an input terminal 431, a first feedback terminal 432, a second feedback terminal 434, and a third feedback terminal 436, a first modulation terminal 433, a second modulation terminal 435, and a reference terminal 437.

The input terminal 431 is configured to receive a working voltage, and the input terminal 431 is electrically connected to an input terminal 441 of the set-up circuit 440. The set-up circuit 440 is configured to receive the working voltage and output a first reference voltage to the V_{AVDD} output terminal 421, and an output terminal 442 of the set-up circuit 440 is electrically connected to the V_{AVDD} output terminal 421. The first divider circuit 451 is electrically connected between the first feedback terminal 432 and the V_{AVDD} output terminal 421. The second divider circuit 452 is electrically connected between the first feedback terminal 432 and the ground, and is also electrically connected to the control circuit 41. The first divider circuit 451 includes a first resistor 461 connected between the first feedback terminal 432 and the V_{AVDD} output terminal 421. The second divider circuit 452 can be a variable resistance unit, which includes a second resistor 462 and a first branch circuit 457 connected in parallel with the second resistor 462. The first branch circuit 457 may include a third resistor 463 and a first switch element 471 connected in series with the third resistor 463. In one embodiment, the first switch element 471 can be a first transistor, with a gate electrode electrically connected to the control circuit 41, a source electrode grounded via the third resistor 463, and a drain electrode electrically connected to the first feedback terminal 432.

The gate reference voltage generator 490 includes an input terminal 491, a first charge pump 492, and a second charge pump 496. The input terminal 491 is configured to receive a continuous alternating square signal. The first charge pump 492 is configured to provide a second reference voltage to the VGH output terminal 422 via the first voltage control circuit 481. The second charge pump 496 is configured to provide a third reference voltage to the VGL output terminal 423 via the second voltage control circuit 485. The first charge pump 492 includes two input terminals 493 and 494, and an output terminal 495. The second charge pump 496 includes two input terminals 497 and 498, and an output terminal 499. The input terminal 491 of the gate reference voltage generator 490 is electrically connected to the input terminal 493 of the first charge pump 492 and the input terminal 497 of the second charge pump 496. The input terminal 494 of the first charge pump 492 is electrically connected to the V_{AVDD} output terminal 421. The output terminal 495 of the first charge pump 492 is electrically connected to the V_{GH} output terminal 422 via the first voltage control circuit 481. The input terminal 498 of the second charge pump 496 is grounded, and the output terminal 499 of the second charge pump 496 is electrically connected to the V_{GL} output terminal 423 via the second voltage control circuit 485.

The first modulation terminal 433 is configured to control a voltage level of the V_{GH} output terminal 422 via the first voltage control circuit 481. The first voltage control circuit 481 includes a first PNP type bipolar junction transistor (BJT) 482 and a resistor electrically connected between a base electrode and an emitter electrode of the BJT 482. The emitter electrode of the first BJT 482 is electrically connected to the output terminal 495 of the first charge pump 492. The first modulation terminal 433 is electrically connected to the base electrode of the first BJT 482. The V_{GH} output terminal 422 is electrically connected to a collector electrode of the first BJT 482. The third divider circuit 453 is electrically connected between the second feedback terminal 434 and the V_{GH} output terminal 422. The fourth divider circuit 454 is electrically connected between the second feedback terminal 434 and the ground, and is also electrically connected to the control circuit 41. The third divider circuit 453 includes a fourth resistor 464 electrically connected between the second feedback terminal 434 and the V_{GH} output terminal 422. The fourth divider circuit 454 can be a variable resistance unit, which includes a fifth resistor 465 and a second branch circuit 458 connected in parallel with the fifth resistor 465. The second branch circuit 458 may include a sixth resistor 466 and a second switch element 472 connected in series with the sixth resistor 466. The second switch element 472 can be a second transistor, with a gate electrode electrically connected to the control circuit 41, a source electrode grounded via the sixth resistor 466, and a drain electrode electrically connected to the second feedback terminal 434.

The second modulation terminal 435 is configured to control a voltage level of the V_{GL} output terminal 423 via the second voltage control circuit 485. The second voltage control circuit 485 includes a second PNP type BJT 486 and a resistor electrically connected between a base electrode and an emitter electrode of the second BJT 486. The emitter electrode of the second BJT 486 is electrically connected to the output terminal 499 of the second charge pump 496. The second modulation terminal 435 is electrically connected to the base electrode of the second BJT 486. The V_{GL} output terminal 423 is electrically connected to a collector electrode of the second BJT 486. The fifth divider circuit 455 is electrically connected between the third feedback terminal 436 and the V_{GL} output terminal 423. The sixth divider circuit 456 is electrically connected between the third feedback terminal 436 and the ground, and is also electrically connected to the control circuit 41. The fifth divider circuit 455 includes a seventh resistor 467 electrically connected between the third feedback terminal 436 and the V_{GL} output terminal 423. The sixth divider circuit 456 can be a variable resistance unit, including an eighth resistor 468 and a third branch circuit 459 connected in parallel with the eighth resistor 468. The third branch circuit 459 may include a ninth resistor 469 and a third switch element 473 connected in series with the ninth resistor 469. The third switch element 473 can be a third transistor, with a gate electrode electrically connected to the control circuit 41, a source electrode grounded via the ninth resistor 469, and a drain electrode electrically connected to the third feedback terminal 436.

When the liquid crystal display 10 is in the normal working mode, the connector 20 transmits the normal image data to the memory 31. The normal image data is latched in the memory 31 and then output to the data processor 33. The data processor 33 coverts the normal image data into normal data signals, and outputs the normal data signals to the data driver 50 via the output unit 35, and additionally, the data processor 33 also outputs control signals corresponding to the normal image data to the timing signal generator 36. Accordingly, the control signal generator 36 generate a first timing signal to the data driver 50 and scanning driver 60. Moreover, the first switch element 471, the second switch element 472, and the third switch element 473 are switched off under the control of the control circuit 41. The voltage generator 42 outputs a reference voltage V_{AVDD} to the data driver 50, and outputs a high-level voltage V_{GH} and a low-level voltage V_{GL} to the scanning driver 60. The scanning driver 60 provides a plurality of normal scanning signals to the liquid crystal panel 70 according to the high-level voltage V_{GH}, the low-level voltage V_{GL}, and the first timing signal. The data driver 50 provides a plurality of normal gray voltage signals to the liquid crystal panel 70 according to the reference voltage V_{AVDD} and the normal data signals. Thus, the liquid crystal panel 70 displays a normal image.

With the described circuit configuration, in the normal working mode, the reference voltage V_{AVDD}, the high-level voltage V_{GH}, and the low-level voltage V_{GL} can be expressed as follows:

V_{AVDD}=V_{FB}(R1+R2)/R2 (1)

V_{GH}=V_{FBP}(R3+R4)/R5 (2)

V_{GL}=V_{FBN}−(V_{REF}−V_{FBN})R5/R6 (3)

In the above formulas, V_{FB} denotes a voltage of the first feedback terminal 432, V_{FBP} denotes a voltage of the second feedback terminal 434, and V_{FBN} denotes a voltage of the third feedback terminal 436. R1, R2, R3, R4, R5 and R6 denote resistances of the first divider circuit 451, the second divider circuit 452, the third divider circuit 453, the fourth divider circuit 454, and the fifth divider circuit 455, and the sixth divider circuit 456 respectively. That is, R1, R2, R3, R4, R5 and R6 denote resistances of the first resistor 461, the second resistor 462, the fourth resistor 464, the fifth resistor 465, the seventh resistor 467, and the eighth resistor 468 respectively.

When the liquid crystal display 10 enters a test mode, the connector 20 transmits a test enable signal to the test initiation circuit 32, which in turn generates and outputs a BIST starting signal to the data processor 33. In response to the BIST starting signal, the data processor 33 converts the predetermined BIST image data into BIST data signals and outputs the BIST data signals to the data driver 50 via the output unit 35. Moreover, the data processor 33 also provides control signals corresponding to the BIST image data to the timing signal generator 36, and provides a HVS test enable signal to the HVS test initiation circuit 34. Accordingly, the timing signal generator 36 generates and outputs a second timing signal to the data driver 50 and the scanning driver 60. The HVS test initiation circuit 34 outputs an HVS starting signal to the DC/DC converter 40 in response to the HVS enable signal. Moreover, upon receiving the HVS starting signal, the control circuit 41 switches the first switch element 471, the second switch element 472, and the third switch element 473 on, and the timer 412 begins clocking the time period of the HVS testing. The voltage generator 42 outputs a test reference voltage V_{AVDD1} to the data driver 50, and a test high-level voltage V_{GH1} and a test low-level voltage V_{GL1} to the scanning driver 60. The scanning driver 60 provides a plurality of test scanning signals to the liquid crystal panel 70 according to the test high-level voltage V_{GH1}, the test low-level voltage V_{GL1}, and the second timing signal. The data driver 50 provides a plurality of test gray voltage signals to the liquid crystal panel 70 according to the test reference voltage V_{AVDD1} and the BIST data signals. Thus, the liquid crystal panel displays a test image corresponding to the predetermined BIST image data.

In the test mode, the test reference voltage V_{AVDD1}, the test high-level voltage V_{GH1}, and the test low-level voltage V_{GL1} can be expressed as follows:

V_{AVDD1}=V_{FB}(R1+R2″)/R2″ (4)

V_{GH1}=V_{FBP}(R3+R4″)/R5″ (5)

V_{GL1}=V_{FBN}−(V_{REF}−V_{FBN})R5/R6″ (6)

In the above formulas, V_{FB} denotes a voltage of the first feedback terminal 432, V_{FBP} denotes a voltage of the second feedback terminal 434, and V_{FBN} denotes a voltage of the third feedback terminal 436. R1, R2″, R3, R4″, R5 and R6″ denote resistances of the first divider circuit 451, the second divider circuit 452, the third divider circuit 453, the fourth divider circuit 454, and the fifth divider circuit 455, and the sixth divider circuit 456 respectively. R1, R3 and R5 denote resistances of the first resistor 461, the fourth resistor 464, and the seventh resistor 467 respectively. Moreover, R2″ denotes parallel resistances of the second resistor 462 and the third resistor 463, and is less than the resistances of the second resistor 462 (R2). R4″ denotes parallel resistances of the fifth resistor 465 and the sixth resistor 466, is less than the resistances of the fifth resistor 465 (R4). R6″ denotes parallel resistances of the eighth resistor 468 and the ninth resistor 469, is less than the resistances of the eighth resistor 468 (R6). That is, R2″<R2, R4″<R4, and R6″<R6. Therefore, according to the above formulae (1)˜(6), it can be found that V_{AVDD1}>V_{AVDD}, V_{GH}>V_{GH}, and V_{GL1}=V_{GL}.

When the timer 412 reaches a predetermined maximum value, that is, the time period of the HVS testing approximately reaches a predetermined HVS test time, the control circuit 41 may inform the voltage generator 42 of an ending of the HVS testing process. In particular, the control circuit 41 switches the first switch element 471, the second switch element 472, and the third switch element 473 off, whereby the output voltages of the voltage generator 42 are recovered from the test-related voltages to the normal working voltages, that is the voltage generator 42 re-outputs the reference voltage V_{AVDD} to the data driver 50, and outputs the high-level voltage V_{GH} and the low-level voltage V_{GL} to the scanning driver 60.

In summary, the LCD 10 employs the connector 20 to transmit the test enable signal to the timing control circuit 30 to start BIST testing, and the timing control circuit 30 further starts HVS testing when the BIST testing is activated. Thus, the BIST testing and the HVS testing are performed on the LCD 10 simultaneously, and testing efficiency is optimized. Furthermore, when the LCD 10 can work in the test mode, with the disclosed configuration of the DC-DC converter 40, no additional test apparatus is required and testing of the LCD 10 is simplified.

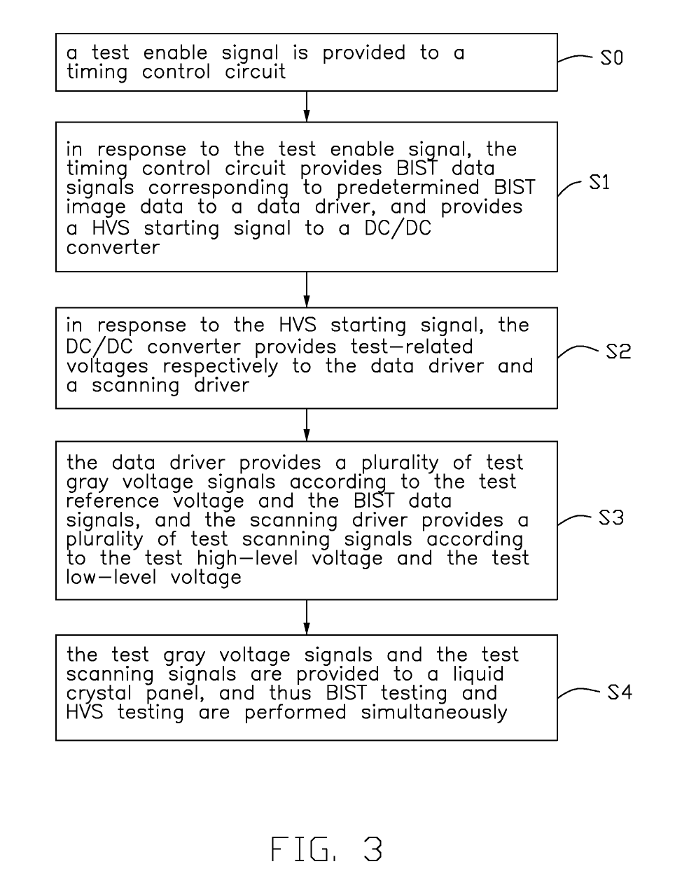

Based on the disclosure, a method for testing an LCD, such as, for example, LCD 10 of FIG. 1, is as follows. Referring to FIG. 3, in step S0, a test enable signal is provided to a timing control circuit 30. In step S1, in response to the test enable signal, the timing control circuit 30 provides BIST data signals corresponding to predetermined BIST image data to a data driver 50, and provides a HVS starting signal to a DC/DC converter 40. In step S2, in response to the HVS starting signal, the DC/DC converter 40 provides test-related voltages (including a test reference voltage, a test high-level voltage and a test low-level voltage) respectively to the data driver 50 and a scanning driver 60. In step S3, the data driver 50 provides a plurality of test gray voltage signals according to the test reference voltage and the BIST data signals, and the scanning driver 60 provides a plurality of test scanning signals according to the test high-level voltage and the test low-level voltage. In step S4, the test gray voltage signals and the test scanning signals are provided to a liquid crystal panel 70, and thus BIST testing and HVS testing are performed simultaneously.

It is to be further understood that even though numerous characteristics and advantages of a preferred embodiment have been set out in the foregoing description, together with details of the structures and functions of the embodiments, the disclosure is illustrative only; and that changes may be made in detail, especially in matters of shape, size and arrangement of parts within the principles of disclosure to the full extent indicated by the broad general meaning of the terms in which the appended claims are expressed.

What is claimed is:

1. A liquid crystal display, comprising:
an interface circuit configured to provide a test enable signal when the liquid crystal display is in a test mode;
a timing control circuit configured to provide build in system test (BIST) data signals and a high voltage stress (HVS) start signal according to the test enable signal, the BIST data signals corresponding to at least one predetermined BIST image;
a DC/DC converter configured to receive the HVS starting signal, and generate test-related voltages in response to the HVS starting signal;
a data driver configured to provide a plurality of test gray voltage signals according to the BIST data signals and the test-related voltages;
a scanning driver configured to provide a plurality of test scanning signals according to the test-related voltages; and
a liquid crystal panel configured to receive the test gray voltage signals and test scanning signals, and correspondingly display the at least one predetermined BIST image.

2. The liquid crystal display of claim 1, wherein the test-related voltages generated by the DC/DC converter comprise a test reference voltage, a test high-level voltage and a test low-level voltage, wherein the test reference voltage is provided to the data driver for generating the test gray voltage signals, and the test high-level voltage and the test low-level voltage are provided by the scanning driver for generating the test scanning signals.

3. The liquid crystal display of claim 2, wherein the DC/DC converter is also configured to provide normal working voltages when the liquid crystal display is in a normal working state, the normal working voltages comprise a reference voltage provided to the data driver for generating normal gray voltage signals, and a high-level voltage and a low-level voltage provided to the scanning driver for generating normal scanning signals.

4. The liquid crystal display of claim 3, wherein the DC/DC converter comprises a control circuit and a voltage generator, and the control circuit is configured to direct the voltage generator to output the test-related voltages upon receiving the HVS starting signal, and direct the voltage generator to output normal working voltages in the absence of the HVS starting signal.

5. The liquid crystal display of claim 4, wherein the voltage generator comprises a V_{AVDD} output terminal and a step-up transformer, the step-up transformer comprising a first feedback terminal, a first divider circuit connected between the V_{AVDD} output terminal and the first feedback terminal, and a second divider circuit connected between the first feedback terminal and the ground; wherein the control circuit adjusts a resistance ratio of the first divider circuit and the second divider circuit to direct the V_{AVDD} output terminal of the voltage generator to selectively output one of the test reference voltage and the reference voltage.

6. The liquid crystal display of claim 5, wherein the first divider comprises a first resistor connected between the V_{AVDD} output terminal and the first feedback terminal, the second divider circuit comprises a second resistor connected between the first feedback terminal and the ground, and a first branch circuit connected in parallel with the second resistor, wherein the first branch circuit comprises a third resistor and a first switch element connected in series with the third resistor, and the first switch element is switched on or off by the control circuit.

7. The liquid crystal display of claim 5, wherein the step-up transformer further comprises a second feedback terminal, the voltage generator further comprises a V_{GH} output terminal, a third divider circuit is connected between the V_{GH} output terminal and the second feedback terminal, and a fourth divider circuit is connected between the second feedback terminal and the ground; and the control circuit adjusts a resistance ratio of the third divider circuit and the fourth divider circuit to direct the V_{GH} output terminal of the voltage generator to selectively output one of the test high-level voltage and the high-level voltage.

8. The liquid crystal display of claim 7, wherein the third divider comprises a fourth resistor connected between the V_{GH} output terminal and the second feedback terminal, the fourth divider circuit comprises a fifth resistor connected between the second feedback terminal and the ground and a second branch circuit connected in parallel with the fifth resistor, the second branch circuit comprises a sixth resistor and a second switch element connected in series with the sixth resistor, and the second switch element is switched on or off by the control circuit.

9. The liquid crystal display of claim 8, wherein the step-up transformer further comprises a third feedback terminal and a reference terminal, the voltage generator further comprises a V_{GL} output terminal, a fifth divider circuit connected between the V_{GL} output terminal and the third feedback terminal, and a sixth divider circuit connected between the third feedback terminal and the reference terminal; the control circuit adjusts a resistance ratio of the fifth divider circuit and the sixth divider circuit to direct the V_{GL} output terminal of the voltage generator to selectively output one of the test low-level voltage and the low-level voltage.

10. The liquid crystal display of claim 9, wherein the fifth divider comprises a seventh resistor connected between the V_{GL} output terminal and the third feedback terminal, the sixth divider circuit comprises an eighth resistor connected between the third feedback terminal and the reference terminal and a third branch circuit connected in parallel with the eighth resistor, the third branch circuit comprises a ninth resistor and a third switch element connected in series with the eighth resistor, and the third switch element is switched on or off by the control circuit.

11. The liquid crystal display of claim 9, wherein the step-up transformer further comprises an input terminal configured to be provided with a working voltage, a first modulation terminal, and a second modulation terminal; the voltage generator further comprises a set-up circuit, a gate reference voltage generator, a first voltage control circuit, and a second voltage control circuit; the input terminal provides a first reference voltage to the V_{AVDD} output terminal via the set-up circuit, the gate reference voltage generator provides a second reference voltage to the V_{GH} output terminal via the first voltage control circuit, and provides a third reference voltage to the V_{GL} output terminal via the second voltage control circuit, the first modulation terminal controls a voltage level of the V_{GH} output terminal via the first voltage control circuit, and the second modulation terminal controls a voltage level of the V_{GL} output terminal via the second voltage control circuit.

12. The liquid crystal display of claim 4, wherein the control circuit comprises a timer configured to control a time period of the test-related voltages output by the voltage generator; when the HVS starting signal is provided to the control circuit, the timer is triggered to count, and the control circuit controls the voltage generator to output the test-related voltages; when the timer reaches a predetermined maximum value, the control circuit controls the voltage generator to stop outputting the test-related voltages, and restart to output the normal working voltages.

13. The liquid crystal display of claim 4, wherein the timing control circuit comprises a test initiation circuit configured to output a BIST starting signal in response to the test enable signal, a data processor configured to selectively provide the BIST image data signals or normal image data signals based on a reception of the BIST starting signal, and a HVS test initiation circuit configured to provide the HVS starting signal to the DC/DC converter in response to the HVS test starting signal.

14. The liquid crystal display of claim 13, wherein the timing control circuit further comprises a data latch for latching the normal image data, the interface circuit is a low voltage differential signaling (LVDS) connector, the connector transmits the test enable signal to the test initiation circuit when the liquid crystal display is in a test mode, and transmits the normal image data to the data latch.

15. The liquid crystal display of claim 14, wherein the timing control circuit further comprises a timing signal generator configured to provide timing signals to the data driver and the scanning driver under the control of the data processor, wherein the timing signal generator generates and outputs a first timing signal when receiving a control signal corresponding to the normal image data, and generates and outputs a second timing signal when receiving a control signal corresponding to the predetermined BIST image data.

16. A method for testing a liquid crystal display, comprising:
providing a test enable signal to a timing control circuit of the liquid crystal display; in response to the test enable signal, the timing controller providing build in system test (BIST) data signals to a data driver of the liquid crystal display, and a HVS starting signal to a DC/DC converter of the liquid crystal display;
in response to the HVS starting signal, the DC/DC converter providing test-related voltages to the data driver and the scanning driver of the liquid crystal display;
generating, by the data driver, a plurality of test gray voltage signals according to the test-related voltages and the BIST data signals, and generating, by the scanning driver, a plurality of test scanning signals according to the test-related voltages; and
outputting the test gray voltage signals and the test scanning signals to a liquid crystal panel, whereby a BIST testing and an HVS testing are performed on the liquid crystal display simultaneously.

17. The method of claim 16, wherein the test-related voltages generated by the DC/DC converter comprise a test reference voltage, a test high-level voltage and a test low-level voltage, wherein the test reference voltage is provided to the data driver for generating the test gray voltage signals, and the test high-level voltage and the test low-level voltages are provided by the scanning driver for generating the test scanning signals.

18. The method of claim 17, wherein the DC/DC converter comprises a control circuit and a voltage generator, and test-related voltages are provided to the data driver and the scanning driver by the control circuit driving the voltage generator to generate and output the test-related voltages upon receiving the HVS starting signal.

19. The method of claim 18, wherein test-related voltages are provided to the data driver and the scanning driver by:
triggering a timer to count when the voltage generator starts to output the test-related voltages;
stopping the voltage generator from outputting the test-related voltages when the timer reaches a maximum value; and
directing the voltage generator to restart outputting the normal working voltages.
